(19) United States
(12) Patent Application Publication
(10) Pub. No.: US 2003/0061104 A1
(43) Pub. Date: Mar. 27, 2003

(54) Internet based warranty and repair service

(76) Inventors: Robert W. Thomson, Bermuda, FL (US); Paul C. Benevides, Bermuda, FL (US); Michael R. Fenn, Riverside, CT (US)

Correspondence Address: WIGGIN & DANA LLP, ATTENTION: PATENT DOCKETING, ONE CENTURY TOWER, P.O. BOX 1832, NEW HAVEN, CT, 06508-1832, US

(21) Appl. No.: 09/808,281

(22) Filed: Mar. 14, 2001

Related U.S. Application Data
(63) Continuation-in-part of application No. 09/526,353, filed on Mar. 16, 2000.

(51) Int. Cl. G06F 17/60

(52) U.S. Cl. 705/26

(57) ABSTRACT

Warranty support for purchased products is provided by an electronic warranty administrator that maintains a plurality of databases. A first database identifies customers, either individuals or corporate entities having warrantied products. A second database identifies the manufacturers of those products. The warranty administrator coordinates between the customer, the manufacturer and a service provider to provide warranty repairs. Unlike conventional extended warranties offered by third parties, the manufacturer remains in the repair process and thereby gains valuable information about the long term satisfaction of the customers. The warranty administrator also provides the manufacturer with a means to contact the customer about other products, product recalls and affinity programs thereby promoting brand loyalty.

### CROSS-REFERENCE TO RELATED APPLICATION

This patent application is a continuation-in-part of United States patent application Ser. No. 09/526,353 entitled “Internet Based Warranty and Repair Service” that was filed on Mar. 16, 2000. The disclosure of United States patent application Ser. No. 09/526,353 is incorporated by reference herein in its entirety.

### BACKGROUND OF THE INVENTION

1. Field of the Invention

This invention relates to a method to provide warranty support to purchasers utilizing an integrated network of computers, such as the Internet. More particularly, the purchasers receive warranty support from a plurality of sellers via the integrated computer network. A first database, accessible via the computer network, contains personalized information about warranties held by a purchaser while a second database, also accessible via the computer network, contains warranty support information provided by multiple sellers. A warranty administrator interfaces with and supports a plurality of purchasers and a plurality of sellers. In accordance with one embodiment of the invention, information related to the purchaser is acquired at the point of sale at the time of the sale. In accordance with a second embodiment of the invention, a warrantable product would include an unactivated pre-paid cash card encoded with product data. In accordance with a further embodiment of the invention, there is provided a comprehensive household warranty for household items.

2. Description of Related Art

When a customer purchases a product from a seller, the seller frequently contractually agrees to replace or repair defective products by means of a warranty. Generally, under the warranty, the seller agrees to pay the cost of labor and materials to repair the defective product or to replace the defective product.

Warranties are usually limited in duration and of no value after the term has expired. Typically, warranties are also limited as to territory and as to owner as well. The warranty may become void if the product is removed from specified territory or transferred from the original owner.

When a customer purchases goods from a retail outlet, that is usually not the same corporate entity as the seller, the retail outlet encourages the purchaser to purchase an extended warranty, extending the term that the product is covered by the warranty and sometimes providing other services such as in-home servicing. Customer fear of the unknown is one reason cited for purchasing the extended warranty and some retail outlets prey on this fear to encourage the purchase of the extended warranty. This is to be understood since the extended warranty is frequently provided by a third party, not the original seller, and the retail outlet earns a significant commission on the sale of the extended warranty. For example, it has been estimated that the extended warranty purchase price paid by the customer is divided among the retailer (receives about 47%), a warranty administrator (receives about 14.5%), brokers (receive about 4%) and an insurer (receives about 34.5%).

In addition to being excluded from the revenue stream, extended warranties are generally not beneficial to the original seller. A third party typically performs repairs and the seller has limited knowledge of product failure causes and frequencies. A poor repair job reflects poorly on the seller, even though out of its control. Further, the seller has no opportunity to utilize the warranty process to promote the sale of additional products manufactured by that seller.

In addition, the seller rarely receives customer specific information from the retail outlet. While statistical data may be provided, such data is of little use to a seller seeking to target a promotional campaign.

The warranty process itself is cumbersome. Typically, the purchaser is expected to fill out a card and mail it to the manufacturer to activate the warranty. Many purchasers neglect this step. While failure to mail the warranty card may not invalidate the warranty, absent such card, the seller may require proof of purchase from the customer. Proof in the form of a receipt may be lost over time. Failure to mail in the warranty card causes the seller to lose control of the goods. The seller is not able to notify the purchaser of product recalls, up-grades or other points of interest to the customer. Furthermore, manufacturers provide little incentive at the time of purchase to complete and mail a warranty card.

In addition, most traditional home warranties, such as those offered by national realtors, typically cover large products such as heavy appliances, plumbing, electrical systems, heating and air conditioning, doorbells, garage openers, burglar/fire alarms, ductwork, and well pumps. These warranties do not extend to cover other important items such as computers, printers, fax machines, digital cameras, DVD's cordless phones, outdoor appliances, and small appliances.

Most sellers have recognized the power of the integrated network of computers referred to as the Internet and most sellers are accessible to consumers through their personal computers utilizing an electronic address, such as URL (Uniform Resource Locator), on the World Wide Web. The seller's web site typically contains new product information and may provide information regarding the repair and servicing of products manufactured by that seller.

Generally, the seller's web site will be limited to its own products and is of no value to a customer seeking warranty support for multiple products from multiple sellers. U.S. Pat. No. 5,987,474, to Sandifer, that is incorporated by reference in its entirety herein, discloses a technical database that stores technical bulletins and other information, including warranty information, necessary to maintain and repair components of complex equipment, such as aircraft.

Other patents have disclosed methods for storing customer sensitive data in a database for the purposes of security and efficiency. U.S. Pat. No. 5,960,411, to Hartman, et al., that is incorporated by reference in its entirety herein, discloses a method and system for placing an order to purchase an item via the Internet and storing customer sensitive data. Customer data is stored in a database and a client identifier is assigned. In the event of a purchase, the client identifier is combined with product purchase information allowing the customer to make a purchase with one action, such as a mouse click.

A number of companies provide purchasers with the opportunity to purchase extended warranties via the World Wide Web. However, none offer a fully automated on-line warranty administration service. Instead, they rely on traditional third party warranty administrators, who operate using verbal communications. Furthermore, these services appear to provide either a single, non-manufacturer, third party source for the warranty or multiple, non-manufacturer, third party sources with the provider selected by a means such as a reverse auction. Furthermore, none offer a comprehensive household warranty that extends to many important household items. The loss of manufacturer control described above is not satisfied by the present services and there remains a need for a computer network based system that provides a purchaser with the ability to create a personalized database containing a listing of products under warranty and that further enables the customer to obtain needed information from any one of a plurality of sellers in an easy and timely manner. In addition, the need remains for a computer network based warranty system that provides added value to the product manufacturer and automates the administration and logistics functions. Furthermore, the need remains for a comprehensive household warranty system to cover all household items.

### SUMMARY OF THE INVENTION

Accordingly, it is an object of the invention to provide an electronic warranty administration system that interfaces between customers and sellers and/or manufacturers. It is a feature of the invention that the warranty administrator is accessible via a single Internet URL. It is a further feature that the warranty administrator supports multiple brands and multiple manufactures. It is a further feature that a comprehensive household warranty can be provided. Still further features of the invention are that the manufacturer remains involved with the warranty repair process and the manufacturer, rather than a third party, sells extended warranties.

It is an advantage of the invention that via the Internet, the warranty administrator provides global customer service and promotes brand loyalty. Other advantages to the purchaser include ease in maintaining warranty records with all warranty records displayed on a personalized home page, ease to review and enhance warranties, and ease in activating a warranty. A further advantage to the customer is automatic notification of product alerts, warranty expirations and manufacturers incentives. Still further advantages of the invention are the automatic registration of a warranty at the point of sale or through the activation of a cash card magnetically encoded with product information at an Automated Teller Machine (ATM), on the Internet, or by phone, and the and the ability to acquire point-of-sale information via the Internet.

Advantages to manufacturers include access to repair statistics that may be used to determine product demographics, to detect fraudulent warranty claims, to determine product failure rates, to determine repair costs and to compare the costs and quality of different service centers.

It is an advantage to the customer to be able to warranty all items in a household. A further advantage to the customer is that through a centralized warranty management system, defective products can be easily exchanged or repaired. An advantage to the retailer is that defective products can be easily exchanged or upgraded by the customer for new products.

In accordance with one aspect of the invention, there is provided a method to provide customer warranty support and repair services via a computer network. The method utilizes at least a first database accessible via the computer network by a plurality of customers. At least one database includes a personalized portion for each one of the plurality of customers that requests warranty support. The personalized portion includes customer data necessary for a seller or manufacturer to provide warranty support of products sold by the seller. There is further at least a second database accessible to a plurality of manufacturers via the computer network that includes a personalized portion for each one of the plurality of manufacturers and contains warranty information regarding products sold by the manufacturer and/or a seller. In addition, a warranty administrator interfaces with and supports both the customers and the manufacturers.

In accordance with a second aspect of the invention, there is provided a method for repairing a defective product. This method includes the steps of (1) a customer accessing a warranty administrator and providing notice of the defective product via an integrated network of computers; (2) the warranty administrator electronically confirming that repair of the defective product is covered by a valid warranty; (3) the warranty administrator determining if in-home repair, in-service center repair, or return of the defective product is most appropriate; (4) the warranty administrator electronically notifying at least one of the manufacturer, the service center, a part distribution center, and a shipper of required activities; (5) the warranty administrator ensuring that the product is properly repaired; and (6) the warranty administrator balancing payments between all involved entities.

In accordance with a third aspect of the invention, the customer and product data is automatically sent to the first database at the point of sale. Such customer data includes without limitation: (1) customer name, (2) billing address, (3) method of payment, (4) account number, (5) payment method identifier, (6) date of purchase, (7) invoice number, (8) e-mail address, and (9) telephone number. Additionally, one or more of the following product data may be sent: (1) description of item, (2) manufacturer, (3) model number, (4) price, (5) serial number, (6) total invoice price, (7) purchase date, and (8) purchase location. Such customer and product data would be sent automatically to the first database in the event the customer used a credit card, debit card, checking account, or other suitable method of payment that was pre-registered with the warranty administrator.

In yet another embodiment of the invention, relevant customer data is replaced with a unique customer identifier. The unique identifier would serve as a substitute for relevant customer data. Additionally, the unique identifier would be sent to manufacturers and customer data would not be made available to manufacturers.

In a further embodiment of the invention, new users would be assigned a unique identifier at the time of registration. The unique identifier would serve as a substitute for relevant customer data and such customer data would not be available to manufacturers. The unique identifier would also be used for the registration of products which were not purchased with a pre-registered credit card, debit card, checking account or other suitable method of payment.

In accordance with a fourth aspect of the invention, product registration would be completed through the use of an unactivated pre-paid cash card that is included with a warrantable product and is encoded with product data. Such product data includes without limitation: (1) description of item, (2) manufacturer, (3) model number, and (4) serial number. Methods of registration of product and activation of pre-paid cash card include without limitation registration via: (1) ATM, (2) Internet, and (3) telephone.

To complete registration of product and activation of pre-paid cash card at an ATM, an ATM card into would be inserted into an ATM machine and a menu option would be selected to register the product. Customers would then be required to insert the cash card into the ATM to complete the product registration and card activation process.

To complete registration of product and activation of pre-paid cash card via the Internet or telephone, a customer would first access a warranty administrator's website or contact a warranty administrator. If a customer had previously registered personal data with the warranty administrator, then the pre-paid cash card's serial number would be transmitted electronically to the warranty administrator. If a customer had not previously registered with the warranty administrator then personal data and the cash card's serial number would be transmitted electronically to warranty administrator.

In accordance with a fifth aspect of the invention there is provided a comprehensive household warranty. This comprehensive household warranty would provide warranty coverage for all items in the household including but not limited to (1) business appliances, (2) consumer electronics, (3) outdoor appliances and (4) small appliances.

In a further embodiment of this invention, the comprehensive household warranty would include a concierge service to pick up and drop off warrantied items in need of repair. The concierge service could also provide a customer with a similar item, available for purchase, while a warrantied item is being repaired. In yet another embodiment of this invention, the warranty administrator would conduct an inventory of a customer's home to determine the scope of coverage available.

### BRIEF DESCRIPTION OF THE DRAWINGS

FIG. 1 illustrates a customer's purchase of a product, and use of the electronic warranty system of the invention for selection of warranty terms.

FIG. 2 illustrates in flow chart format a system for providing a consumer with warranty support and repair services via an integrated computer network.

FIG. 3 illustrates a customer's personalized home page.

FIG. 4 displays information utilized to establish or up-date a customer's profile.

FIG. 5 displays a customer's repair status.

FIG. 6 displays a customer's screen for entering a new problem requesting a warrantied repair.

FIG. 7 displays a manufacturer's portal.

FIG. 8 displays a service provider portal.

FIG. 9 displays a service provider's manufacturer specific grid.

FIG. 10 displays a service provider's customer specific grid.

FIG. 11 displays an electronic warranty administrator's portal.

FIG. 12 displays electronic warranty administrator service offering choices.

FIG. 13 displays the electronic warranty administrator system conceptual component architecture

FIG. 14 illustrates a model of the warranty system of the invention for in home repair.

FIG. 15 illustrates a model of the warranty system of the invention for product repair by a service provider.

FIG. 16 illustrates a model of the warranty system of the invention for replacement of a defective product.

FIG. 17 displays electronic warranty administrator home page

FIG. 18 illustrates in flow chart format a system for automatically sending data to a manufacturer at the point of sale and the use of registered payment methods.

FIG. 19 illustrates in flow chart format a system for product registration through the use of an unactivated pre-paid cash card that is encoded with product data and included with a warrantable product.

### DETAILED DESCRIPTION

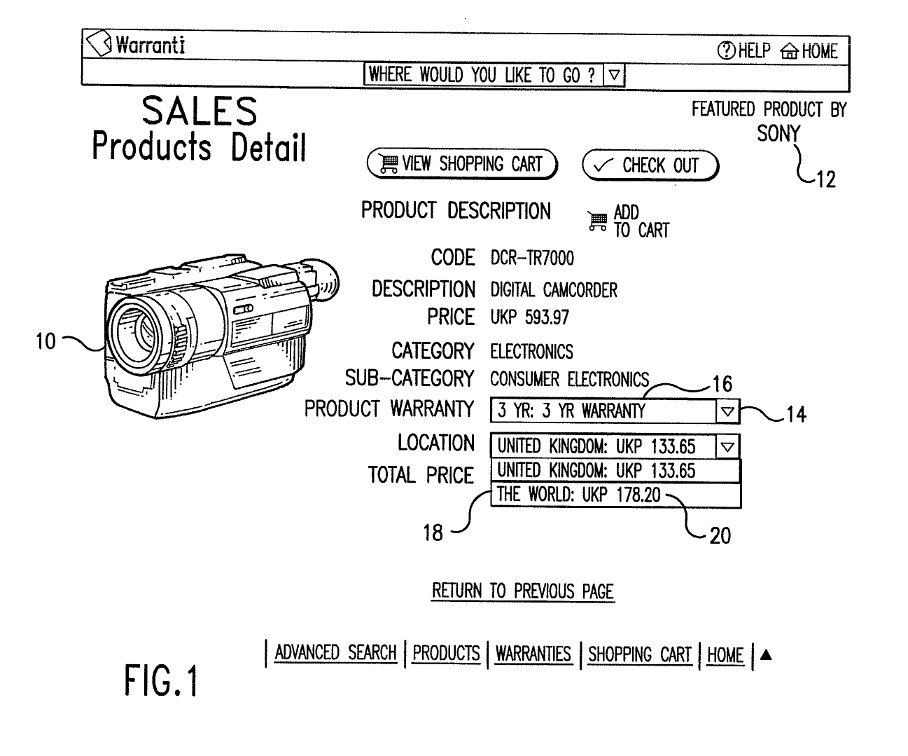

With reference to FIG. 1, at the outset, a customer purchases a product 10 from a seller 12 who has registered with an electronic warranty administrator, such as ConXia, Inc., of Wilmington, Del. Throughout this patent application, the purchaser/customer may be an individual or corporate entity. The seller may be a manufacturer or non-manufacturer, such as a retail outlet. Since the system provides significant enhanced value to manufacturers, it is anticipated that each manufacturer will pay a sign up fee to become a member of the system and then a transaction fee for each warranty repair. It is anticipated the service will be at no cost to the customer.

At the time of purchase, a customer is given an opportunity to purchase an extended warranty 14 from a manufacturer. Typically, the product purchase price includes a basic, for example one year, warranty that may be further limited as to territory and product owner. The warranty term 16 and/or territory 18 may be extended by payment of an additional fee 20. If not purchased at this time, an extended warranty may be purchased at a later time.

When the customer purchases the product 10, the seller 12 captures the initial information about the customer, the product and the selected warranty and transmits this information to the electronic warranty administrator, where the information is stored in a database as described below.

While FIG. 1 illustrates an on-line purchase, the warranty system of the invention is equally amenable to purchases from actual “brick and mortar” stores, catalogs and other sources.

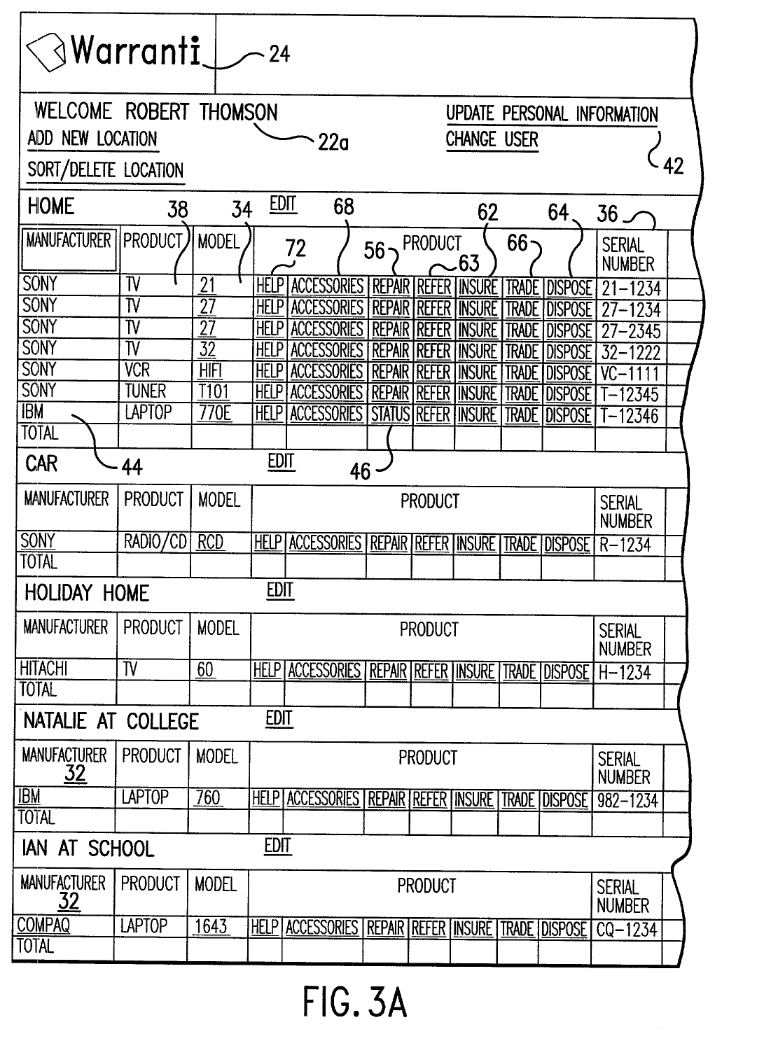

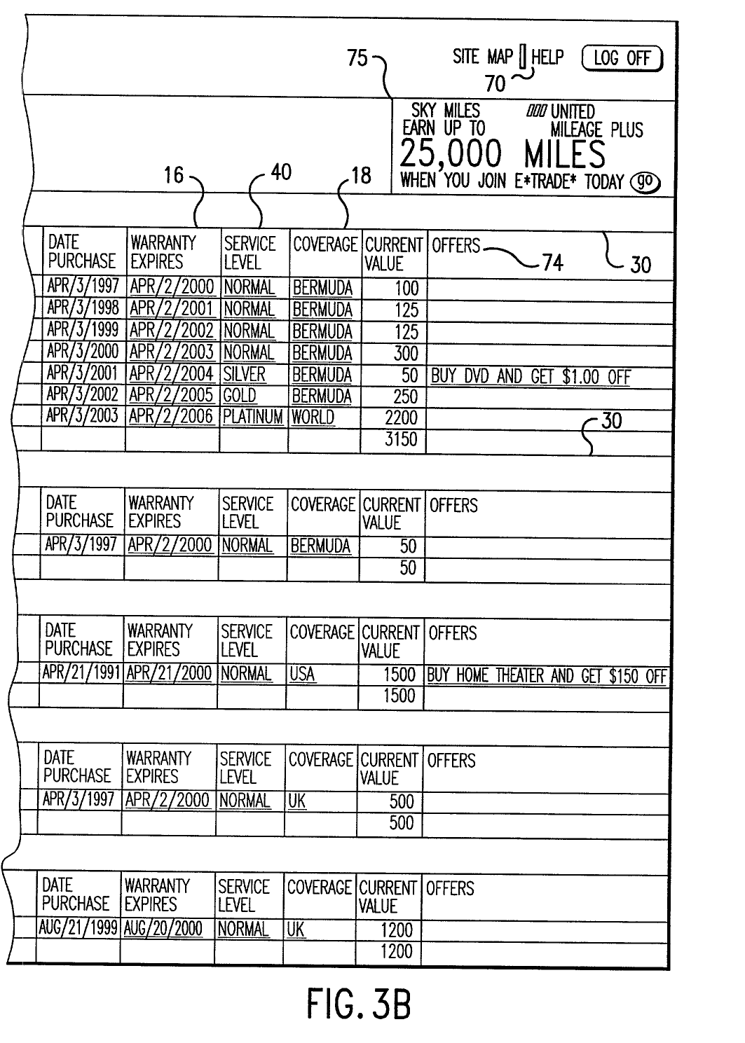

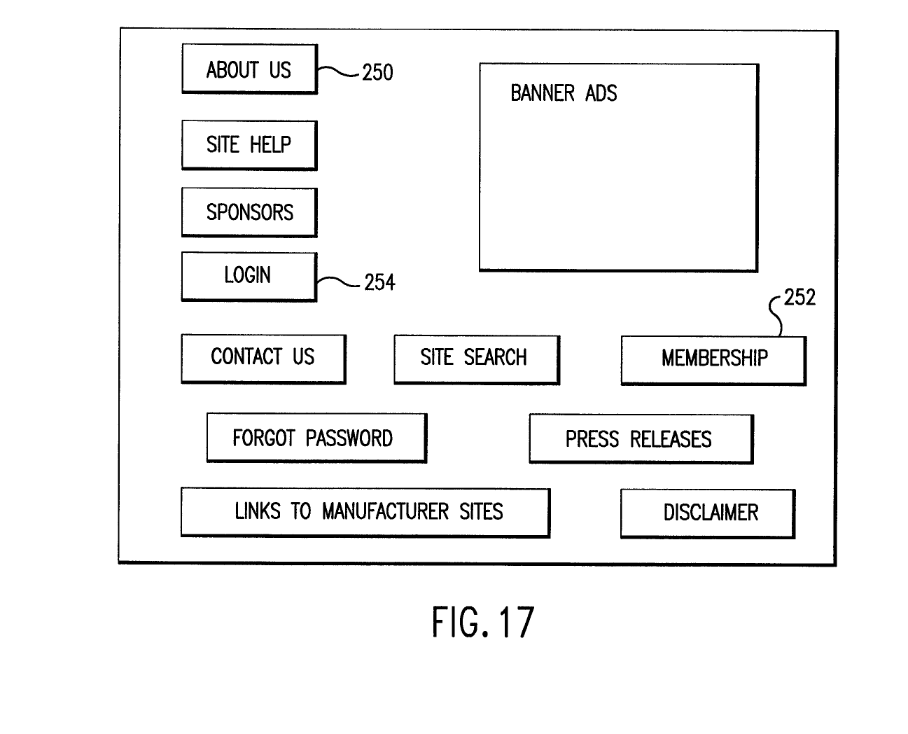

The electronic warranty administrator then sends the purchaser a welcoming email that includes the warranty administrator's URL (which will enable the customer to access the warranty administrator's home page, as displayed in FIG. 17), plus login instructions and a password which will enable the customer to access their personalized home page (FIG. 3). The customer is also asked to verify the accuracy of the customer profile in possession of the electronic warranty administrator and to up-date or correct as needed. Accessing the warranty administrator's home page gives the user multiple options including learning more about 250 the warranty administrator, learn about the benefits of membership in the warranty service 252, and the ability of a member to login 254 and thereby be identified as a proper user of the service and further be identified to the warranty administrator as a customer, manufacturer, service provider or shipper.

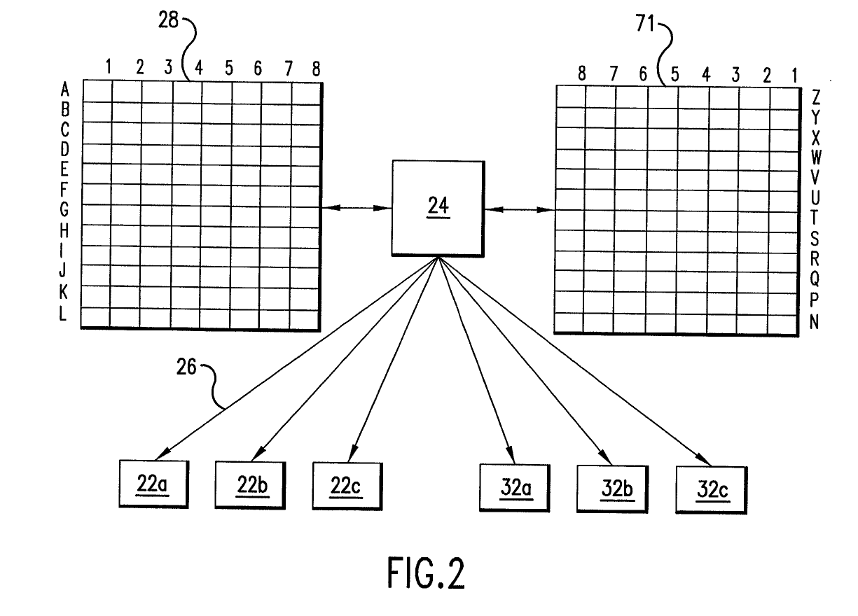

FIG. 2 illustrates in flow chart format a system for providing a consumer with warranty support and repair services on an integrated computer network. A plurality of customers (illustrated as 22a, 22b, 22c although in actual practice the number of consumers would number in the thousands or millions and could be distributed globally) access an electronic warranty administrator 24 through an integrated computer network 26, such as the internet. Typically, a customer 22a will communicate electronically with the warranty administrator by locating the electronic warranty administrator 24 through its URL using a conventional internet web browser such as Netscape Explorer (Netscape Communications Corporation, Mountain View, Calif.) or Microsoft Navigator (Microsoft Corporation, Redmond, Wash.). Communication between the customer's computer and the electronic warranty administrator's computer is by a conventional communication format such as TCP/IP (transmission control protocol/internet protocol).

When properly identified to the electronic warranty administrator by means of an appropriate log-in and password sequence, the customer 22a receives access to a first database 28. The first database 28 contains a plurality of addressable personalized portions (A1, A2, A3 . . . L6, L7, L8). Each customer is associated with a specific personalized portion, for example, customer 22a may be associated with personalized portion G4. The electronic warranty administrator 24 limits the customer's access to the first database 28 to that customer's personalized portion.

While information is described as stored in a database, it is recognized that any data repository may be utilized. The data may be distributed between multiple separated databases. In which case the data contains a unique tag to identify the customer.

Each customer's personalized portion contains sufficient data about that customer's purchases and warranty support of those purchases to enable the warranty support and repair services as described herein. Each customer is provided with a personalized home page as illustrated in FIG. 3. The customer's personalized home page enables the customer 22a to interact with the electronic warranty administrator 24 as well as with the first database. This page is preferably customizable, and will allow the customer to sort by various fields, e.g. locations of products 30, manufacturer 32, etc. One or more links provide the customer with access to additional information about the electronic warranty administrator and electronic connections to related web sites. Information such as the manufacturer's model number 34, product serial number 36, and a description 38 of the product are provided. Additional information includes the original warranty term 16, countries covered by the warranty 18 and the warranty service level 40. Expiration is expressed as date, and optionally, time of day as well.

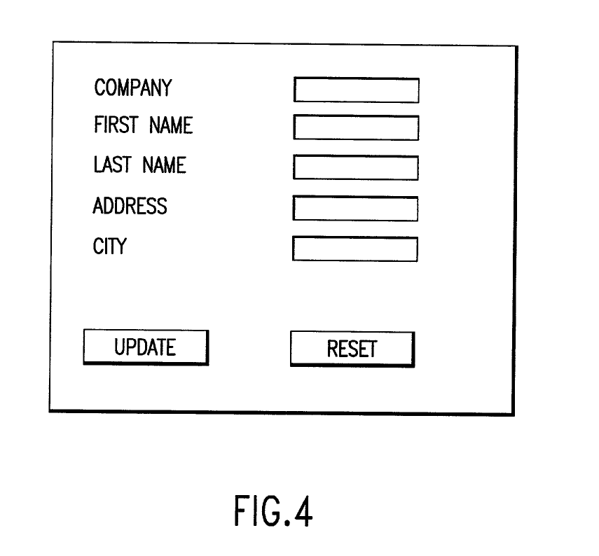

Selecting the update personal information link 42 presents the customer with a screen of the type illustrated in FIG. 4 for modifying the customer's profile. The customer can update selected portions of information or reset to clear the information and update the entire information data field. Information provided to the electronic warranty administrator includes without limitation, customer's company (if any), customer's name, a billing address and a shipping address (if different), telephone number, facsimile number, and email address. Additional information may relate to the service and shipping level required, service and shipping may be provided at a “routine” level or at a premium level, such as using expedited service and overnight couriers, likely at a higher price. For security, a password may be required to enable changing of the profile.

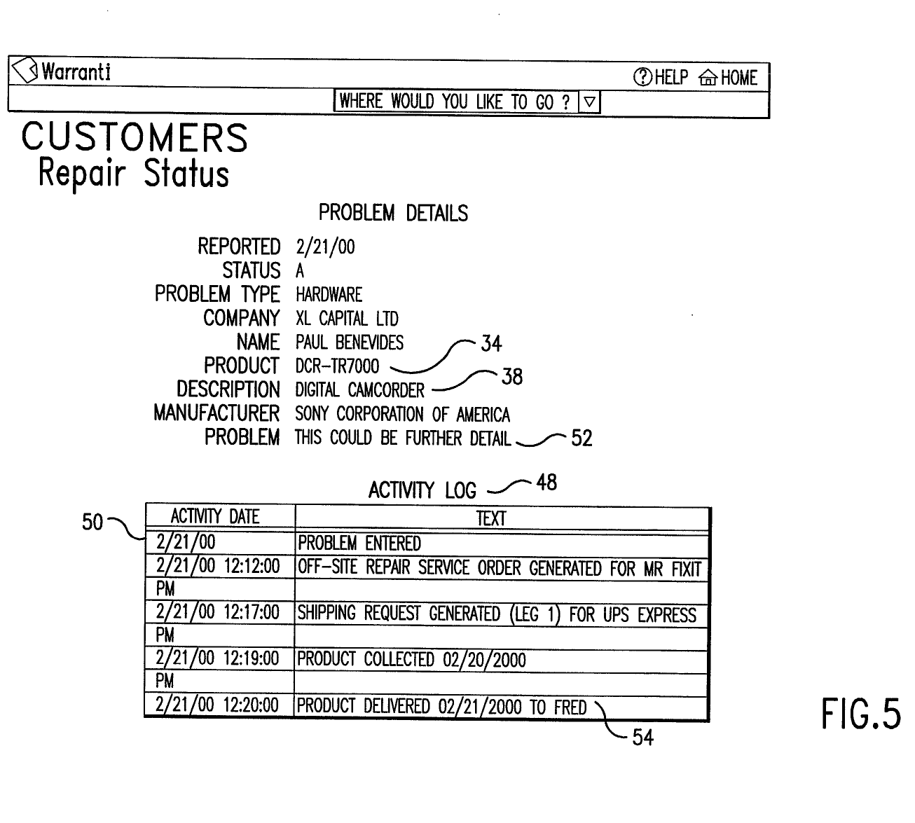

Referring back to FIG. 3, products presently either requiring repair or being repaired are identified, such as by highlight bar 44. The products have a status link 46. Selecting the status link 46 provides the customer with access to a repair status tracking screen as illustrated in FIG. 5. The repair data activity 48 includes the date a problem was reported 50, the model number 34, the product description 38, the problem 52 and current status 54, typically as the last entry in the repair data activity log 48. This screen enables the customer to determine where the item being repaired is at any point in time.

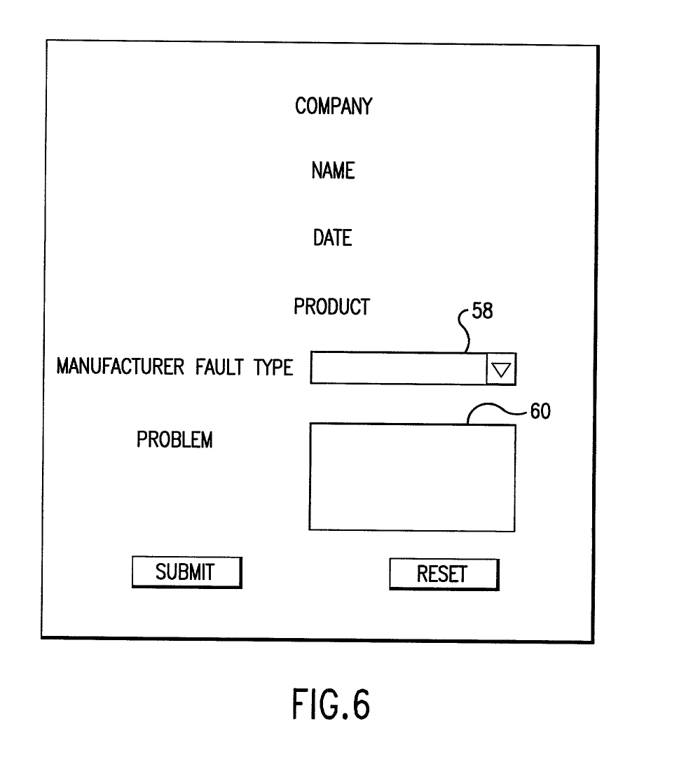

Referring back to FIG. 3, selecting a repair link 56 enables the customer to access a new problem window as illustrated in FIG. 6. Information such as the customer's company and name has been previously established through the login procedure and the electronic warranty administrator also sets the present date. The first database (28 in FIG. 2) already contains a listing of the customer's warrantied products, and selecting the repair link ( 56 in FIG. 3) for a given product allows the customer to verify the product in question is under warranty. If so, manufacturer's fault type pop-down window (58 in FIG. 6) may be opened to identify the most common problems reported for the specific product or to identify any outstanding product recalls. Alternatively, or in addition to, the manufacturer's fault type pop-down window 58, the customer may enter a textual description of the problem in define problem field 60.

Following entry of the requested problem information, the customer may elect to submit the information to the electronic warranty administrator or select reset to re-enter the necessary information.

Referring back to FIG. 3, selecting the insure link 62 enables the customer to communicate with one or more insurance companies that provide insurance for the product against theft, loss, damage, etc. The insurance may be sold through the electronic warranty administrator or through third party insurers. Refer link 63 enables the customers to recommend the product to third parties. Should a third party subsequently purchase the product, the customer may be eligible for cash or an affinity reward.

The dispose link 64 directs the customer to information about the proper disposal of the product. This information may include hazardous constituents of the product that require specialized disposal, such as lead batteries. The information may also identify product components that may be recycled. Based on the consumer profile, the warranty administrator knows where the product was utilized and provides information about disposal regulations applying for that location.

Selecting trade-in link 66 enables the customer to communicate with the original manufacturer to determine if the manufacturer will offer a trade-in allowance to encourage brand loyalty for a new purchase. Alternatively, or in addition, the trade-in link 66 enables the customer to access secondary markets, such as on-line auction houses, for example eBay.com (San Jose, Calif.) enabling the consumer to attempt to sell the product on a secondary market. Selecting the accessories link 68 links the customer with the original manufacturer to determine if accessories for the product are available, e.g. alternate power supply, carry case, etc. Product up-grades may include parts shipped to the customer for in-home up-grades or require sending the product to an authorized repair service or the manufacturer, as described below, for up-grade.

Selecting warranty expires 16 allows the customer to exercise available options to extend the term of the warranty, the territory in which the warranty is effective, the service level, and the individuals covered by the warranty, for example if the product is sold.

Selecting the help link 70 enables the customer to communicate with the electronic warranty administrator interactive help system.

Selecting manufacturer's help link 72 enables the customer to access the manufacturer's on-line product help. Message field 74 provides information of value to the customer such as sales, affinity programs and advertisements for products that may be of interest. Advertising window 75 displays advertisements for non-competing products.

Referring back to FIG. 2, a plurality of manufacturers 32a, 32b, 32c communicate with the electronic warranty administrator 24 through the integrated computer network 26. While three manufacturers are illustrated, in practice there will likely be thousands of manufacturers located globally communicating with the warranty administrator. Information about each manufacturer and that manufacturer's products is stored in addressable form in second database 71. For example, each manufacturer's information may be stored in a specific cell (such as S5) in a single database or have an identifiable tag and stored in multiple addressable databases.

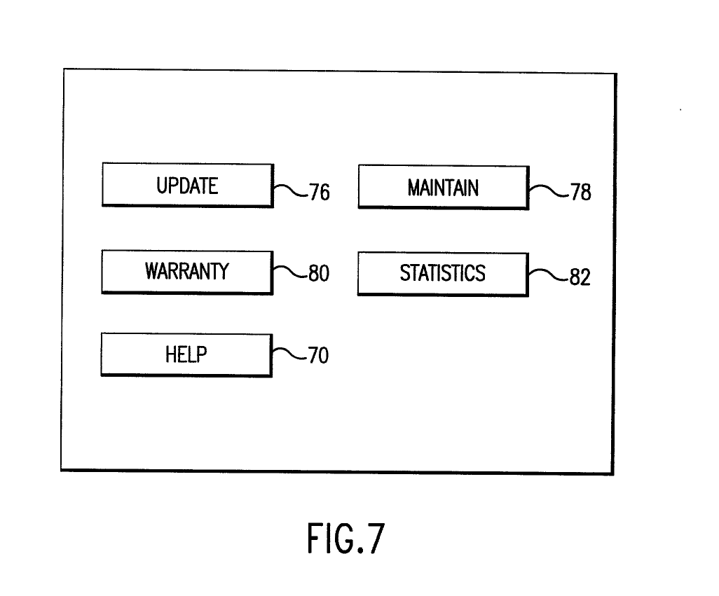

When a manufacturer enters the manufacturer's portal, as illustrated in FIG. 7, it is prompted to login and enter a password to identify the manufacturer. The manufacturer has a number of options including updating 76 the manufacturer's information. Such an update may include contact information as well as manuals, promotions and other information of value to purchasers of the manufacturer's products. The update field also contains information needed by the warranty administrator to control the warranty process. This information includes product weight, replacement cost, portions of the product that are serviceable or replaceable by the customer and a listing of authorized repair services.

Selecting maintain 78 opens a screen illustrating the manufacturer's products sorted by a category such as manufacturer's code, product description, general product category (such as electronics) and one or more sub-categories (such as consumer electronics and/or mobile). Still further information maintained about the product is the product cost, either retail, manufacturer's cost or both.

Selecting warranty 80 identifies for each of the manufacturer's products, the standard warranty that comes with the product when purchased and extended warranty options, if available. Rather than a third party selling the extended warranty, the manufacturer offers the extended warranty and, based on repair statistics 82, bases the extended warranty price on actual cost to the manufacturer and not as a third party source of revenue. Of course it is within the manufacturer's discretion to add a premium to the extended warranty cost to enhance value to the manufacturer. Table 1 illustrates an extended warranty field as controlled by the manufacturer.

TABLE 1

| Warranty Code | Warranty Term | Cost to Consumer |
|---|---|---|
| 1 YR | Standard One Year | -0- |
| 2 YR | Extended Two Year | $15 |
| 3 YR | Extended Three Year | $20 |
| 4 YR | Extended Four Year | $23 |
| 5 YR | Extended Five Year | $25 |

Selecting repair statistics 82 opens a window giving the manufacturer useful information about its products. The statistics will identify warranty claims submitted and the outcome of these claims. An abnormally high number of early repair requests may identify to the manufacturer a defect that is better serviced by a recall or by the sending of a repair or up-grade to purchasers. Taking a proactive stance raises the esteem of the manufacturer in the eyes of the customers.

Warranty requests late in the anticipated life of a product identifies to the manufacturer a customer who may be better served by replacement and affords the opportunity for the manufacturer to proactively contact the consumer with a discount coupon or other incentive to remain brand loyal.

Selecting help 70 enables the manufacturer to communicate with the electronic warranty administrator interactive help system.

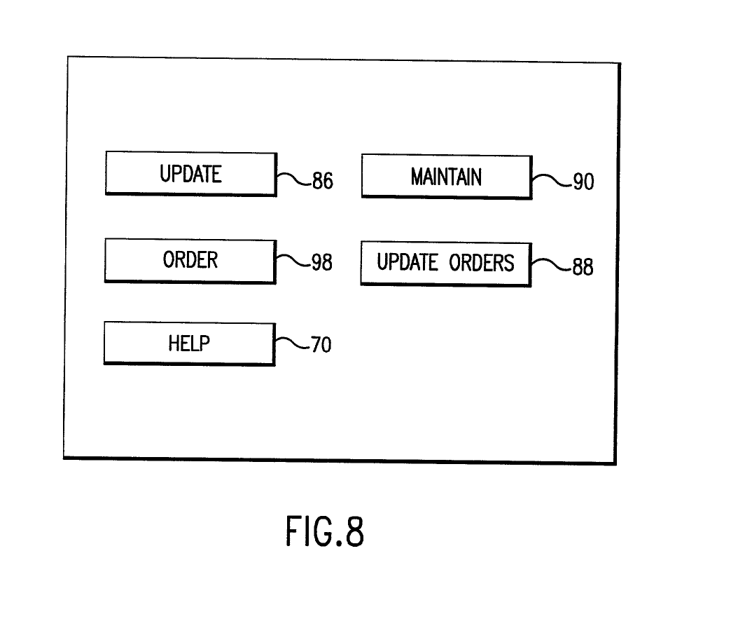

The service provider portal provides a login screen that identifies the viewer as a service provider. A service provider portal screen as illustrated in FIG. 8 is then displayed. The update link 86 enables the service provider to update contact information. Likewise, update order link 88 enables the service provider to modify the cost of specific repairs and the time required to make those repairs.

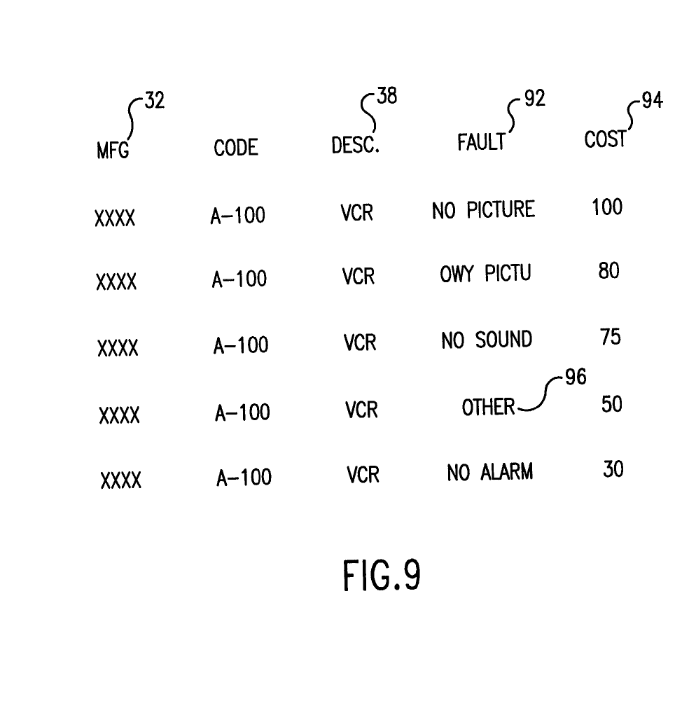

The maintain service rates link 90 identifies the products serviced by the service provider and agreed upon cost. With reference to FIG. 9, a manufacturer specific grid is displayed identifying the manufacturer 32, the manufacturer's product code and a brief product description 38. Under the fault column 92 are common problems for a specific product and the cost column 94 identifies the agreed upon repair price. An “other” default 96 within the fault column 92 sets an hourly rate or some other agreed upon rate for undefined problems.

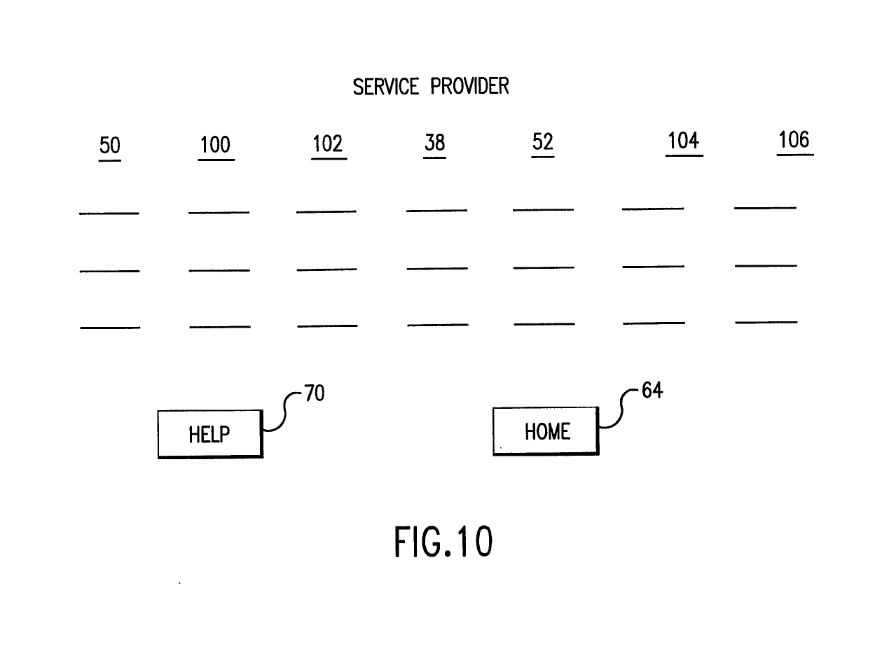

Referring back to FIG. 8, order link 98 may be selected to display, as illustrated in FIG. 10, the status of a customer's products presently with a service provider. Information that may be presented includes the date the problem was first reported 50 and when a repair order was established 100. The information will likely include a manufacturer's product code 102, product description 38 and a brief summary of the problem 52.

The days since the problem was reported 104 and the estimated days remaining until the problem will be solved 106 are also recorded so that the consumer or manufacturer has a reasonable expectation of when the product may be placed back into service. Help button 70 enables the service provider to access the electronic warranty administrator's interactive help system.

Shipper contact information and rates will be automatically updated via an interface to shipper's sites.

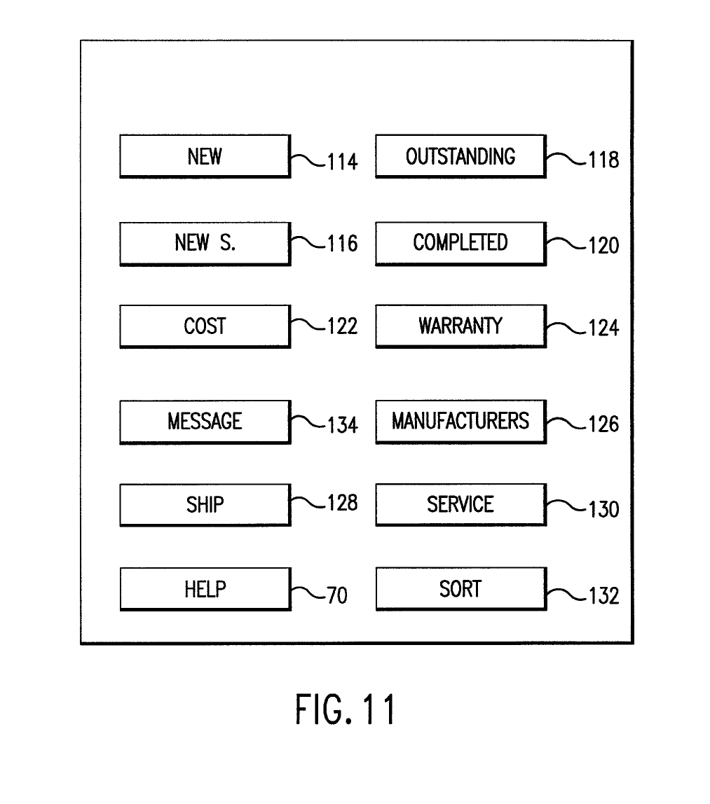

From the warranty administrator's portal, illustrated in FIG. 11, the warranty administrator may select new problems 114 to view newly submitted problems from customers. Typically, the problem report will be of a form similar to that illustrated in FIG. 6. Based on the type of problem, manufacturer and location of the customer, the warranty administrator will select an appropriate service provider. This selection may be done by computer, for example utilizing a logic program to determine the most economical repair center, to balance the number of service requests among multiple providers or as specified by a manufacturer. Alternatively, a warranty administrator may manually select the service provider.

Once the service provider is selected, a service order is prepared and sent as a new service order 116 to the service provider. The warranty administrator can then monitor outstanding service problems 118, viewing information of the type displayed in FIG. 10 to identify service providers who are not meeting the specified repair requirements, such as time to repair or cost. Completed service orders 120 may be monitored to insure the product is shipped back to the proper customer and also to enable follow-up such as in the form of customer satisfaction surveys, a promotion for the same or different products, or an affinity program award.

The warranty administrator may calculate the cost 122 of repairs to insure the manufacturer is debited and the service provider credited for warranty repairs. For this function, and any other function described herein, the warranty administrator may utilize any required currency. If there is a deductible, the customer may also be appropriately debited by this function.

A number of master control screens allow the warranty administrator to obtain data about the warranties 124 managed by the warranty administrator, manufacturers 126, shipper 128 and service providers 130 who are serviced by the warranty administrator. A sort function 132 enables any of the above data to be provided by manufacturer, location, cost, or any other function entered into the database.

The message function 134 enables the warranty administrator to send messages to consumers (for example via message field 74 in FIG. 3), shippers, manufacturers, and/or service providers. Such messages may be personalized, identifying when a particular problem will be solved or when a warranty expires, and narrow cast to a single viewer or may be more general, for example advertising a promotion or rate change, and broadcast to all viewers or to a class of viewers. Product up-dates, recall notices and product support bulletins may also be transmitted via the message function.

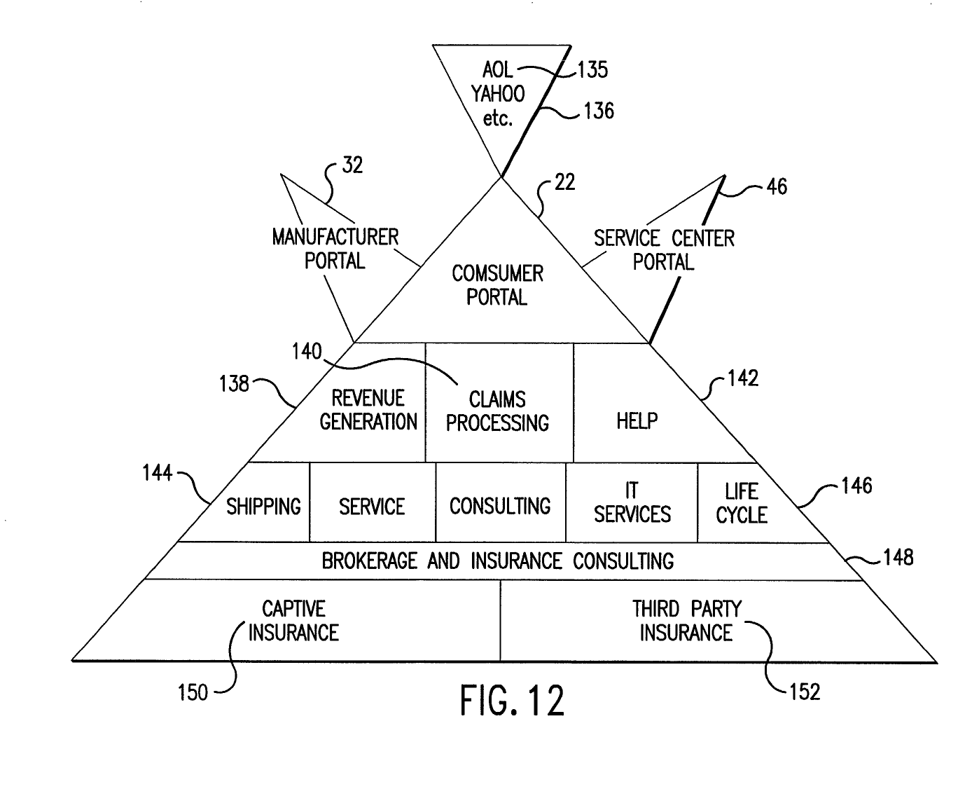

FIG. 12 illustrates the various services available from an electronic warranty administrator. The purchaser's portal may be accessed through the warranty administrator's URL, through an internet service provider 135 such as America-On-Line, through a search engine 136 or by any other suitable means. From the purchaser's portal (FIG. 3), the customer has access to manufacturers' web sites (link 32 ). This access enables the customer to view products offered by the manufacturer and either purchase those products, purchase an extended warranty for a manufacturer's product or request additional information about a product. The customer's portal also has status links (link 46) enabling them to track the status of the products being repaired.

Referring back to FIG. 12, the warranty administrator interfaces with the customer, the manufacturer and the service center to generate revenue 138. The manufacturer generates revenue by the sale of new products, the sale of up-grades and by the sale of extended warranties. Since the customer is directed to the manufacturer for these services, the customer is more likely to remain brand loyal for subsequent purchases. Revenue is generated for the service provider by being requested to provide warranty repairs. The warranty administrator manages payments from the manufacturer and from the customer removing the need for the service provider to conduct that function. The customer also benefits by having a record of warranties and an easy process to obtain warranty repairs.

The warranty administrator further processes claims 140 originating from customers and transmits the required information to the manufacturer and to the service provider. The warranty administrator notifies the customer if the product is to be sent to a service provider. If so, a mailing label and postage may be electronically sent to the consumer.

The warranty administrator help function 142 is intended to resolve problems either by an entity or between entities and make the warranty service process as user friendly as possible.

Other services of the warranty administrator are coordinating shipping 144 of products both from the customer to the service provider and from the service provider back to the customer. The warranty administrator may identify a preferred shipper and agreed upon level of shipping service. Mailing labels and prepaid postage may also be sent electronically.

Other services provided by the warranty administrator may include consulting services, identifying warranty claim trends and product sales trends. This information could enable the manufacturer to maximize revenue by tailoring products and repair services to best meet those trends. The warranty information will also give the manufacturer a better view of the lifecycle 146 of its products. The warranty administrator may go beyond warranty repair and offer the purchaser insurance 148 for the product as well. Such insurance may be against theft, loss, damage, obsolescence or any other factor. Insurance may also be offered to manufacturers to defray the cost of providing warranty repairs. The insurance may be provided via the warranty administrator as captive insurance 150 or through a third party 152.

When a customer experiences a problem with a product, a direct link 32 from that item's line on their customer home page will take them to the product manufacturer's interactive help for that specific product. If the manufacturer's help system does not enable the consumer to resolve the problem unassisted, or if the consumer cannot for some reason access the manufacturer's help, a toll-free telephone number to an expert call center having a script to help solve most common problems will be available as backup. If the problem cannot be resolved via these measures, repair assistance should be requested and will be provided according to the warranty contract terms.

While a product may still be under warranty, the manufacturer may deem the product obsolete and that replacement or up-grade is preferable. This information may be electronically communicated to the consumer to allow an educated decision. The manufacturer may offer the consumer a trade-in allowance, rebate or other incentive to replace or up-grade.

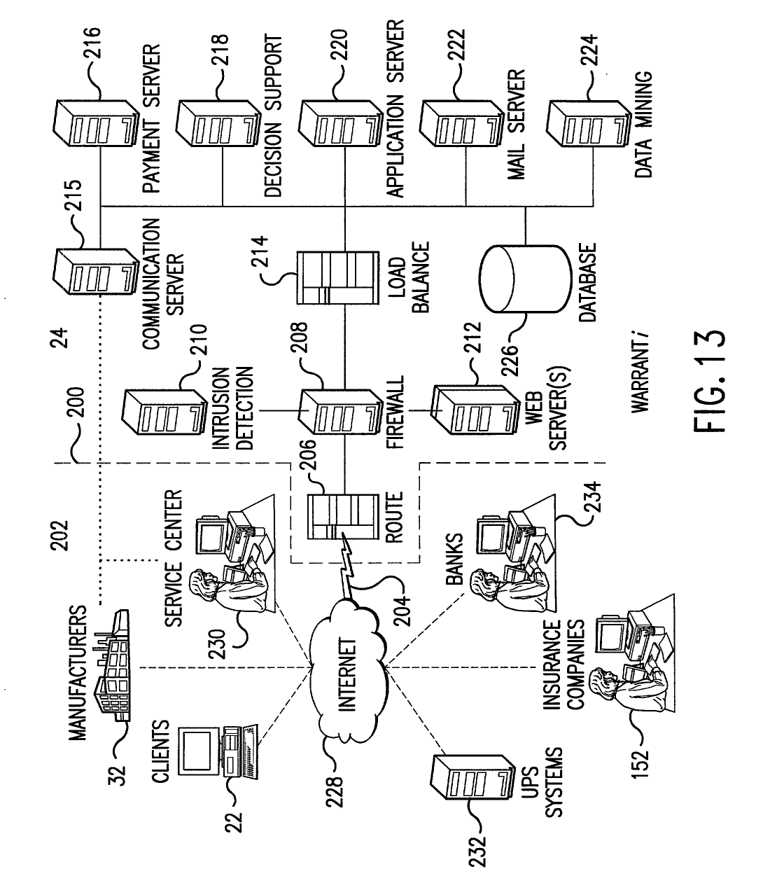

FIG. 13 schematically illustrates hardware useful to support the electronic warranty administration of the invention and the integration of that hardware with the internet, manufacturers, purchasers and service providers. The electronic warranty administrator 24 is represented by the devices on the indicated side of the dashed line 200 with the public features 202 on the opposing side of the dashed line. A high speed, high band width interface 204 links the warranty administrator 24 to the public side. When an internet service provider directs an entity to the electronic warranty administrator, a router 206 directs the electronic traffic to a firewall 208 and an intrusion detection server 210. This ensures that only legitimate users access the service and also secures the service from mischievous attacks.

After passing through firewall 208, the electronic traffic is directed to a web server 212. The web server 212 responds to client requests and forwards the request for processing by one or more of a number of servers, that are preferably independent of each other and task specific.

The load balance server 214 allocates tasks to other servers in order to balance the workload among a series of servers. This allows for easy expansion and scalability of the whole warranty administration process.

The payment server 216 initiates the payments between parties. This server will interface with the banking system through the communication server 215 over a private network.

The decision support server 218 runs analytic applications that provide statistical information to original sellers, service centers and electronic warranty administrator. This information will be used to help efficiently manage the warranty programs.

The application server 220 runs the main electronic warranty administrator application, which will record the purchase and warranty details for products acquired by the clients. It will also handle the servicing of requests for on-line assistance and fault reporting and tracking. This server will be used to present the customer personal home pages to the clients

The mail server 222 interfaces between the application server and the Internet email service. When the electronic warranty administration application server needs to notify a third party (client, original seller, service center etc) it will format an email message and use the mail server to send it to the recipient. The mail server will also handle the processing of all incoming mail and responses to outgoing mail. It is intended that sophisticated levels of automation will be used to ensure that incoming mail is handled with as little human intervention as possible.

The data mining server 224 analyzes the application server transactional data for nuggets of information that may enable fraud detection and other productivity measure to improve the processing of transactions.

The database 226 holds all data associated with purchases and warranty related transactions. All other servers will have access to this data. The electronic warranty administrator communicates via the internet 228 or other integrated network of computers using TCP/IP protocol. This protocol is used to handle the communication between all servers on the network. In addition it is expected that HTTP (HyperText Transfer Protocol), FTP (File Transfer Protocol) protocols will also be used. Data moving over the network between the servers will use HTML (HyperText Markup Language) and XML (Extensible Markup Language) formats. While these protocols and formats are believed well known to one skilled in the art, appended to this patent application, and incorporated herein by reference, are more detailed descriptions of the protocols and formats.

Clients/customers 22 log on to the Internet and access their customized personal home page. This home page allows them to access warranty detail information and to process tasks for individual items. These tasks could be related to getting product help, reporting the need for repair or tracking the progress of an item through the repair process.

Manufacturers/original sellers 32 accept the purchase orders from the client and arrange delivery of products and accept liability for the warranty contract conditions.

Service center 230 carries out repair work for the client. The work is authorized by the warranty administrator and paid for by the original seller or its insurance company.

UPS systems 232 is a tracking system, typically global, that may be administered by UPS (United Parcel Service, Inc. of Atlanta, Ga.) or another private, quasi-public or public shipper and is used to handle the logistic and tracking of the movement of product and spare parts.

Insurance companies 152 provide the original seller with a policy to cover all or part of the cost of servicing the warranty contract.

Banks 234 act as the conduit for the movement of payments between the clients, original sellers, service centers, shipping agents, insurance companies and the electronic warranty administrator.

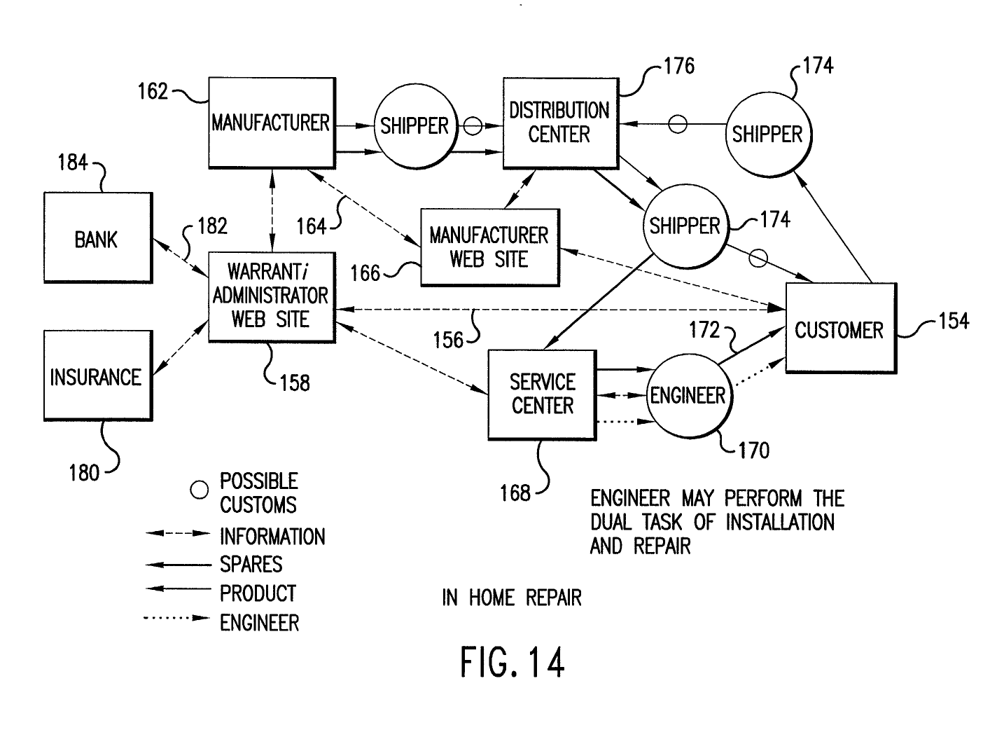

FIG. 14 graphically illustrates one possible repair assistance scenario, in home repair. A customer 154 electronically notifies 156 the warranty administrator 158 of a problem. After confirming the repair is covered by a valid warranty, the warranty administrator 158 determines that the problem may be solved by in-home repair and electronically notifies 164 the customer and the appropriate service center 168. If the manufacturer's interactive help has determined that replacement parts are required, that information is electronically transmitted 160 to the warranty administrator 158. Required spare parts may be shipped 174 from a distribution site 176 affiliated with the manufacturer 162 or shipped 174 from the service center 168.

The service center then has an engineer 170 or other technically skilled person contact 172 the customer 154 and assist the customer in repair. This assistance may be electronic, by telephone or in person if required.

Once the problem has been resolved, the warranty administrator 158 determines 178 whether, in addition to warranty coverage, the customer 154 had insurance coverage 180 as well. Payments from the manufacturer 162, from the customer 154, if a deductible is due, and from the insurer 180, if applicable are then credited against the charges incurred by the service center 168, distribution center 176 and engineer 170 via 182 bank 184.

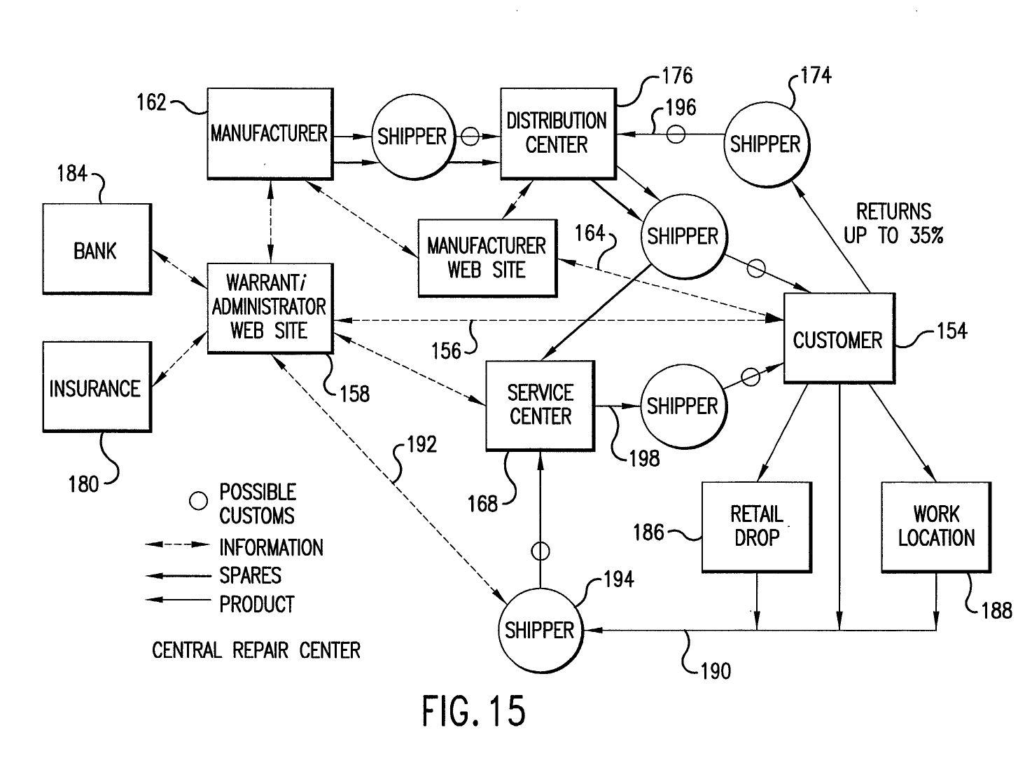

FIG. 15 graphically illustrates a model in which the customer 154 is instructed to send the product to a service center for repair. The customer 154 electronically notifies 156 the warranty administrator 158 of the problem. Product return may be instructed by the warranty administrator who notifies the customer 154 and the service center 158. The customer 154 is then notified 156 by the warranty administrator 158 where to return the product. This information may contain shipping instructions, a shipping label and postage if within the scope of the warranty.

The customer then either brings the product to a retail shipping service location 186 or has it picked up at the customer's location 188 for shipment 190 to service center 168. The shipping service may be a private entity such as Federal Express (Federal Express Corp. of Memphis, Tenn.) or UPS, a quasi-private entity such as the United States Postal Service or a public entity such as a public postal system. Communication 192 between the warranty administrator 158 and the shipper 194 enables the customer to keep track of the product during shipment and alerts the service center 168 when to expect delivery of the product. Spare parts required by the service center 168 for the repair are shipped from manufacturer's distribution center 176 to the service center. When the repairs are complete, the service center ships the repaired product back to the consumer 154.

After the repairs are complete, the warranty administrator 158 coordinates payment with the insurance company 180, if any, and bank 184, as above.

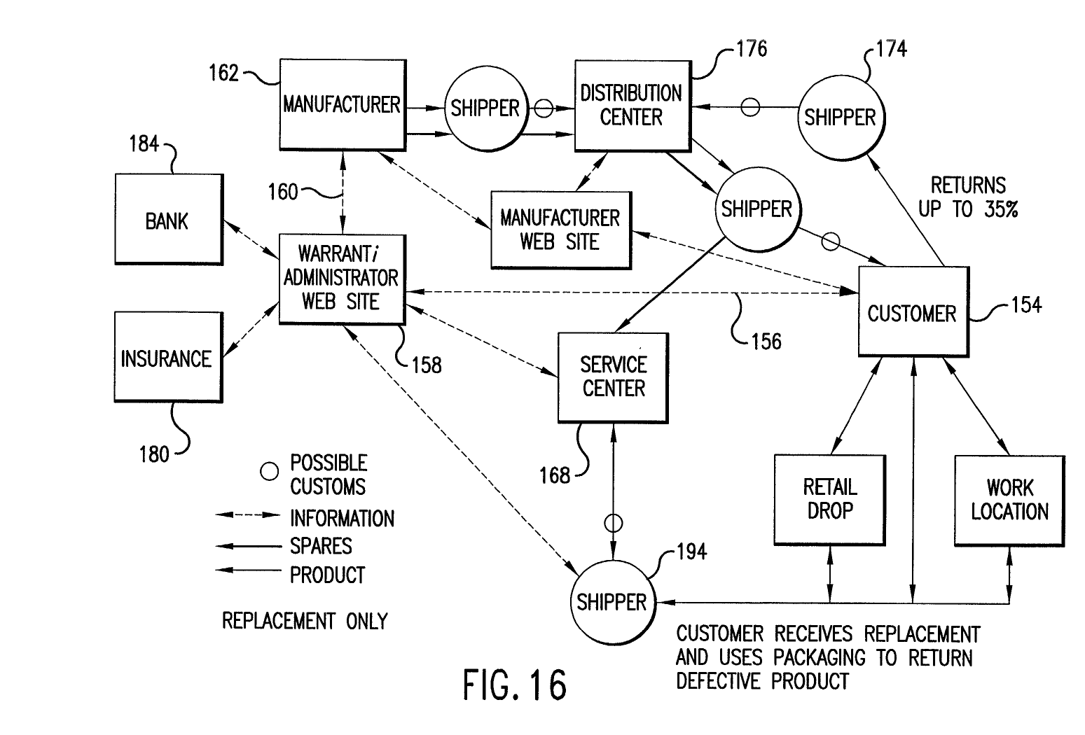

FIG. 16 graphically illustrates a model in which the customer 154 receives a replacement product and, optionally uses the replacement packaging to return the defective product. Customer 154 electronically notifies 156 the warranty administrator 158 of the defective product. The warranty administrator then notifies the customer that the product is to be returned and that a replacement product will be received. Manufacturer's distribution center 176 is notified to ship a replacement product to the customer.

The customer then receives return instructions. In a preferred embodiment, the customer 154 utilizes the replacement product packaging material to package the defective product which is then shipped 194 to service center for repair, for parts, for recycling or disposal. As with previous embodiments, costs between the various entities are then rectified by the warranty administrator 158 utilizing the services of the insurance company 180, if any, and bank 184.

Shipping speed, product repair rates and other statistics are then sent to the manufacturer by the electronic warranty administrator.

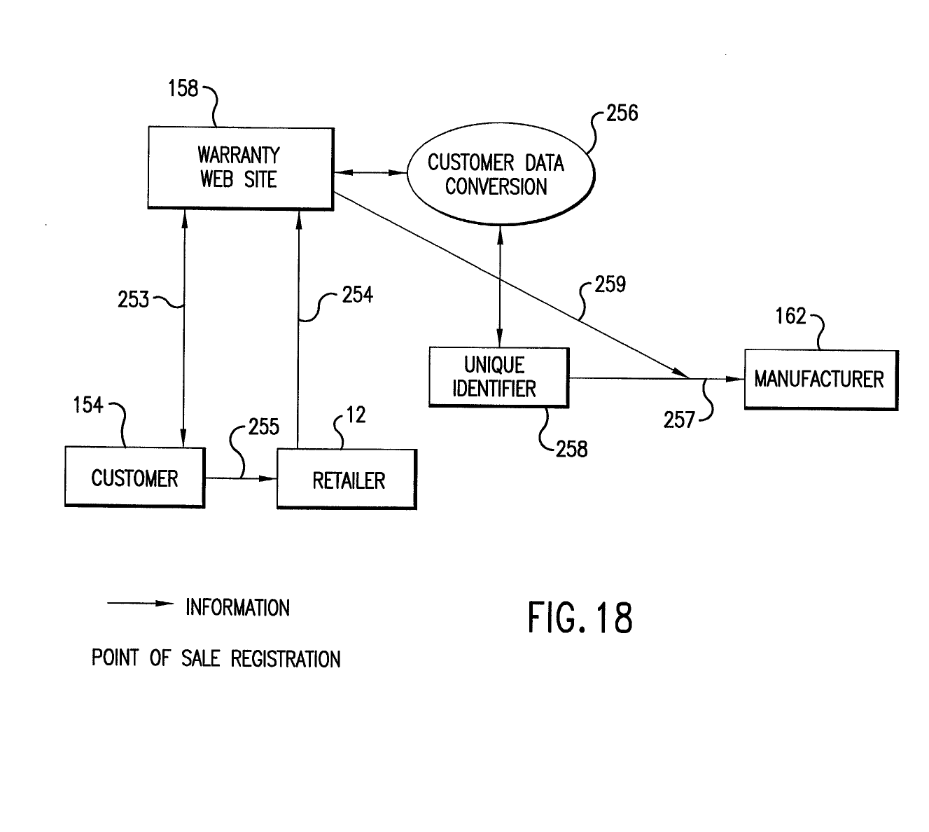

FIG. 18 illustrates in flow chart format a system for the registration of a payment method and the receipt by a customer of a unique customer identifier. Customer 154 notifies 253 the warranty administrator by any suitable means, such as electronically or by mail 158 that he would like to participate. The warranty administrator collects customer data that as a non-exclusive list may include: (1) customer name, (2) billing address, (3) method of payment, (4) account number, (5) payment method identifier, (6) date of purchase, (7) invoice number, (8) e-mail address, (9) telephone number, and optionally registers a payment method such as a credit card, debit card, or checking account. The warranty administrator assigns the customer data 256 to a unique customer identifier 258 and electronically notifies 253 the customer of the unique identifier. The customer would then use this unique identifier to register warranties for previously purchased products. Additionally, the unique identifier would be used to register all future product warranties.

In an alternative embodiment, FIG. 18 illustrates in flow chart format a system for sending data automatically to a manufacturer at the point of sale. A customer 154 purchases a product with a registered payment method such as a credit card, debit card, checking account, cash, on terms, or other suitable method of payment from a retailer 12, including but not limited to a retail outlet, Internet store, or mail order catalog. The customer data that as a non-exclusive list may include: (1) customer name, (2) billing address, (3) method of payment, (4) account number, (5) payment method identifier, (6) date of purchase, (7) invoice number, (8) e-mail address, (9) telephone number and product data 254 as a non-exclusive list including: (1) description of item, (2) manufacturer, (3) model number, (4) price, (5) serial number, (6) total invoice price, (7) purchase date, and (8) purchase location is transmitted electronically 253 to the warranty administrator. The customer data is assigned 256 to a unique identifier 258. The unique identifier 258 and the product data 259 are transmitted electronically 257 to the manufacturer 162 to register the appropriate warranty or for other purposes including but not limited to statistical or demographic analysis. In the event the customer had previously been assigned a unique identifier, then that identifier and the product data would be transmitted electronically 259 to the manufacturer.

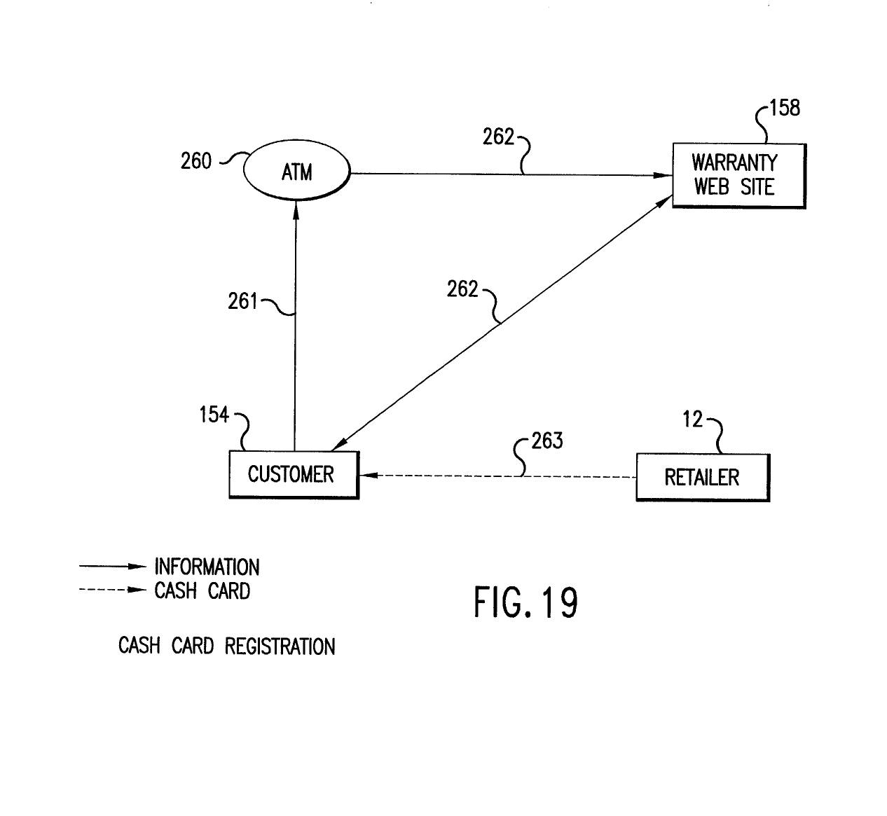

FIG. 19 illustrates in flow chart format a system for product registration through the use of an unactivated pre-paid cash card that is encoded with product data and included with a warrantable product. A customer 154 purchases a warrantable product with an unactivated pre-paid cash card 263 encoded with product data including without limitation: (1) description of item, (2) manufacturer, (3) model number, and (4) serial number, from retailer 12. Cash card serial number and customer data as a non-exclusive list including without limitation: (1) customer name, (2) billing address, (3) method of payment, (4) account number, (5) payment method identifier, (6) date of purchase, (7) invoice number, (8) e-mail address, (9) telephone number is transmitted electronically 262 without limitation via the (1) Internet, or (2) telephone, to warranty administrator 158 for registration of product and activation of cash card.

In an alternative embodiment, FIG. 19 illustrates in flow chart format a system for product registration through the use of an unactivated pre-paid cash card that is encoded with product data and included with a warrantable product through the use of an ATM machine. A customer 154 purchases a warrantable product with an unactivated pre-paid cash card 263 encoded with product data including without limitation: (1) description of item, (2) manufacturer, (3) model number, and (4) serial number, from retailer 12. Cash card is inserted into ATM 260. Cash card serial number and customer data as a non-exclusive list including without limitation: (1) customer name, (2) billing address, (3) method of payment, (4) account number, (5) payment method identifier, (6) date of purchase, (7) invoice number, (8) e-mail address, (9) telephone number is transmitted electronically 262 to warranty administrator 158 for registration of product and activation of cash card.

In an alternative embodiment, a customer 154 purchases a comprehensive household warranty. A warranty administrator 158 collects data from customer 154 via on-site collection or, as a non-exclusive list, (1)customer input via an integrated network of computers, (2)telephone, or (3)mail. In a further embodiment, the warranty administrator 158 utilizes an algorithm to calculate a service contract price for each customer based on, as a non-exclusive list, (1) product reliability, (2) repair costs, (3) consumer data, (4) total value of goods in household, (5) age of product, (6)type and amount of usage, and (7) warranty status. The warranty administrator 158 may also maintain a database of customer products, repair frequency, and cost of repair and utilize a household appraiser to determine the cost of a service contract. In a still further embodiment. the warranty administrator 158 coordinates a network of manufacturers and product repair vendors to resolve reported product failures while a product is being repaired. If an item is reported to a warranty administrator for repair, the item would be picked up from and dropped off to the customer.

In an alternative embodiment, a warranty administrator 158 provides a customer 154 with a loaner item while a defective or broken item is being repaired. The customer 154 reports a defective or broken item to the warranty administrator 158. The warranty administrator 158 picks up the reported item for repair and leaves a loaner item for the customer to use. The customer 154 can purchase the item directly from the warranty administrator 158. In an alternative embodiment, loaner items are provided by manufacturer 162 or retailer via the warranty administrator 158.

It is apparent that there has been provided a warranty system FIG. 13 that utilizes an integrated network of computers that fully satisfies the objects, features and advantages set forth above. While the invention has been described in combination with embodiments thereof, it is possible that many alternatives, modifications and variations will become apparent to those skilled in the art in light of the foregoing description. Accordingly, it is intended to embrace all such alternatives, modifications and variations as fall within the spirit and broad scope of the appended claims.

We claim:

1. A method to provide customer warranty support and repair services via a computer network, comprising:
at least a first database accessible via said computer network by a plurality of customers, said at least one database including a personalized portion for each one of said plurality of customers that requests warranty support, said personalized portion including customer data necessary for a manufacturer to provide warranty support of products sold by said manufacturer or manufacturer authorized seller;
at least a second database accessible to a plurality of said manufacturers via said computer network, including a personalized portion for each one of said plurality of manufacturers containing warranty information regarding products sold by said manufacturer or said manufacturer authorized seller; and
a warranty administrator interfacing with and supporting both said plurality of customers and said plurality of manufacturers.

2. The method of claim 1 wherein said customer and said seller communicate electronically with said warranty administrator via an integrated network of electronic devices.

3. The method of claim 2 further comprising the step of registering a customer's method of payment with warranty administrator.

4. The method of claim 3 wherein said customer data is sent to said first database at the point of sale.

5. The method of claim 4 wherein said customer data is sent automatically to said first database when said registered payment method is used.

6. The method of claim 5 wherein said customer data is converted to a unique identifier.

7. The method of claim 6 wherein said unique identifier is communicated electronically to manufacturer.

8. The method of claim 2 wherein said customer has a comprehensive household warranty.

9. The method of claim 8 wherein said customer with said comprehensive household warranty can contact the warranty administrator via an integrated network of computers such as the Internet.

10. The method of claim 9 wherein said comprehensive household warranty includes concierge service.

11. The method of claim 10 wherein said concierge service provides a loaner item for said customer while warrantied item is being repaired or replaced.

12. The method of claim 2 wherein said warranty administrator has a home page accessible via the Internet through which customers, manufacturers, service providers and shippers may access respective portals.

13. The method of claim 2 wherein said product includes a pre-paid unactivated cash card encoded with product data.

14. The method of claim 13 wherein said product is registered by transmitting electronically said cash card serial number and said customer data to said warranty administrator from an ATM.

15. The method of claim 13 wherein said product is registered by transmitting electronically said cash card's serial number to said warranty administrator.

16. The method of claim 12 wherein said warranty administrator is accessible via a URL.

17. The method of claim 16 wherein said customer portal includes a personalized home page for each customer that displays warrantied products owned by that customer.

18. The method of claim 17 wherein said warrantied products are sortable by a function selected from the group consisting of product location, manufacturer, and warranty expiration date.

19. The method of claim 18 wherein a highlight bar identifies warrantied products requiring repair and a status button electronically links the customer to a customer status page maintained by said warranty administrator utilizing information provided by said service provider.

20. The method of claim 18 wherein a repair button electronically links said customer to a problem report screen enabling said customer to identify said product and a problem with said product.

21. The method of claim 20 wherein said problem report screen includes a pop-down window of commonly reported problems for said product.

22. The method of claim 20 wherein said personalized home page provides additional information to said customer about each said product selected from the group consisting of accessories, insurance, trade-in, disposal, serial number, purchase date, warranty expiration date, warranty service level, warranty territory and said products current value.

23. The method of claim 22 wherein selecting said trade-in electronically links said customer to information regarding said manufacturer's trade-in and up-grade policy and secondary markets.

24. The method of claim 12 wherein said manufacturer's portal accesses a personalized manufacturer's home page from which the seller may add information to said second database, said information including manuals, promotions, up-grades and accessories related to said manufacturer's products.

25. The method of claim 24 wherein said manufacturer's portal includes a warranty screen whereby said manufacturer may display and maintain warranty and extended warranty coverage.

26. The method of claim 25 wherein said manufacturer may obtain warranty repair insurance from said warranty administrator.

27. The method of claim 25 wherein said manufacturer may electronically retrieve repair statistics from said warranty administrator.

28. The method of claim 20 wherein when a customer reports a problem, said warranty administrator electronically communicates said problem to a service provider.

29. A method for repairing a defective product comprising the steps of:
a customer accessing a warranty administrator and notifying said warranty administrator of said defective product via an integrated network of computers;
said warranty administrator electronically confirming that repair of said defective product is covered by a valid warranty;
said warranty administrator determining if in-home repair, in-service center repair, or return of said defective product is most appropriate;
said warranty administrator electronically notifying at least one of said manufacturer, said service center, a part distribution center, and a shipper of required activities;
said warranty administrator ensuring that said product is properly repaired; and
said warranty administrator balancing payments between all involved entities.

30. The method of claim 22 wherein when in-home repair is appropriate, said warranty administrator electronically coordinates between said customer, a service provider engineer and a distribution site in replacement parts are required.

31. The method of claim 22 wherein when in-service center repair is appropriate, said warranty administrator electronically coordinates between said customer, said service center and said shipper.

32. The method of claim 24 wherein said shipper electronically transmits shipping instructions to said customers.

33. The method of claim 22 wherein when return of said defective product is appropriate, said warranty administrator electronically coordinates between said customer, said manufacturer and said shipper.

34. The method of claim 26 wherein said shipper electronically transmits shipping instructions to said customers.
